(19) United States
(12) Patent Application Publication
(10) Pub. No.: US 2015/0134309 A1
(43) Pub. Date: May 14, 2015

(54) METHOD AND APPARATUS FOR ESTIMATING THE SHAPE OF AN ACOUSTIC TRAILING ANTENNA

(71) Applicant: ATLAS ELEKTRONIK GmbH, Bremen (DE)

(72) Inventor: Florian Schulz, Bochum (DE)

(21) Appl. No.: 14/397,772

(22) PCT Filed: Apr. 11, 2013
(86) PCT No.: PCT/EP2013/057577

§ 371 Date: Oct. 29, 2014

(30) Foreign Application Priority Data
May 7, 2012 (DE) 10 2012 009224.5

(51) Int. Cl. G06F 17/50; G06F 17/18

(52) U.S. Cl. CPC G06F 17/50; G06F 17/18
USPC 703/2

(57) ABSTRACT

The invention concerns a method and a device for estimating the shape of an acoustic trailing antenna (12), wherein the shape is estimated using Kalman filtering. In the process, the deterministic part (u(kᵢ)) of the equation of state of the Kalman-Filters is initially set to zero. In addition, successive discrete points in time (kᵢ) are predefined and at each predefined point in time (kᵢ), an estimated shape of the trailing antenna (12) is described by a model-based state vector (x(kᵢ)). Here, the model-based state vectors (x(kᵢ)) are determined by the estimated time behavior of a mechanical model (24) of the trailing antenna (12) and by the movements of a pull point (16) of the trailing antenna (12) assumed to be known. The deviation of the respective current model-based state vector (x(kᵢ)) is determined for one or more previous model-based state vectors (x(kᵢ₋₁)), regarded as a current matrix (\tilde{F}(kᵢ)) and the current transition matrix (F(kᵢ)) is regularly updated for the Kalman filtering using the matrices (\tilde{F}(kᵢ)) determined.

The invention concerns a method for estimating the shape of an acoustic trailing antenna using Kalman filtering in accordance with the preamble of claim 1, and a device for estimating the form of an acoustic trailing antenna using the Kalman filtering in accordance with the preamble of claim 15.

A method for estimating the shape of a trailing antenna is presented, for example, in “Towed Array Shape Estimation Using Kalman Filters—Theoretical Models”, IEEE Journal of Oceanic Engineering, vol. 18, No. 4, pp. 543-556, 1987, D. A. Gray, B. D. O. Anderson and R. R. Bitmead. In the method envisaged, the shape of the trailing antenna is estimated on the basis of the measurements of the depth sensors and compasses incorporated into a trailing antenna, using Kalman filtering.

For the method in question, in order to be able to apply the Kalman filtering, a trailing antenna is required, which consists of a homogeneous, thin, flexible and neutrally trimmed cylindrical float, wherein the float has acoustic sensors. The float thus corresponds to the acoustic section of an actual trailing antenna. In addition, the head of the float is assumed to be a pull point and its pull point movement to be known. Furthermore, it is assumed that the pull point movements are uniform and lineal.

The estimation process envisaged represents a suitable method for estimating the shape of a trailing antenna, wherein the estimation is only possible for the special cases given by the abovementioned assumptions. These special cases are fulfilled so long as the vessel towing the trailing antenna performs only classic “straight course maneuvers”.

In the actual case, however, the acoustic section or the float is drawn through a body of water using a towing cable. In that case, a pull point should be assumed, which does not correspond to the head of the acoustic section or of the float, but to the point of attachment between the vessel towing the trailing antenna and the towing cable. Here, then, one of the conditions for the estimation of the shape using the Kalman filtering is already lacking since, in this case, a homogeneous float should no longer be assumed. In particular, the dragline and the acoustic section have different physical characteristics. As well, especially in any curved passage, an estimation of the shape of the trailing antenna is necessary in order also to determine the positioning of the acoustic sensors in these curved passages since only acoustic signals recorded in this way can be reliably processed.

Thus, the object underlying the invention is to find an estimation of the shape of a trailing antenna using Kalman filtering, which can also be applied under actual conditions without the abovementioned limiting conditions.

The invention achieves this object by a method for estimating the shape of an acoustic trailing antenna using Kalman filtering in accordance with claim 1 and by a device for estimating the shape of an acoustic trailing antenna using Kalman filtering in accordance with claim 15.

In accordance with the invention, the shape of an acoustic trailing antenna is estimated using conventional Kalman filtering, that is, using the equations known as a Kalman filter. Here, however, in contrast to the conventional application of the equations, the deterministic part of the equation of state of the Kalman filter is initially set to zero.

In addition, discrete points in time are also predefined for the successive calculations performed in the Kalman filtering, and estimated shapes of the trailing antenna at the predefined points in time are each described by a model-based state vector. These model-based state vectors are determined at the respective points in time by the estimated time behavior of a mechanical model of the trailing antenna and by assumed known movements of any point of the trailing antenna defined as a pull point. This pull point corresponds e.g. to the point of attachment between a vessel towing the trailing antenna and a towing cable of the trailing antenna, wherein the location or the movement of the pull point due to known course maneuvers of the vessel is then always known.

In addition, the trailing antenna is assumed to be divided into several segments. A current model-based state vector of a point in time, then, has estimated values of the current locations, orientations and/or shapes of several or all of the segments or values derived from these values. These values or these values derived from the values are determined using the mechanical model of the trailing antenna and of the pull point movement.

In addition, one of the predefined points in time, in which the shape of the trailing antenna is to be estimated using the Kalman filtering, is selected as the current point in time in each case. The model-based state vector of the respectively current point in time is designated as a current model-based state vector. In addition, the deviation of the respectively current model-based state vector from one or more previous, that is, determined at previous points in time, model-based state vectors is determined. This deviation, then, describes the change of the mechanical model over time due to forces exerted on the trailing antenna, e.g. by pull point movements, currents, gravity or buoyancy. The respective currently determined deviation is then regarded as a matrix or is converted into a matrix or is depicted as a matrix and this matrix is converted into the transition matrix for the Kalman filtering, so that the transition matrix for the Kalman filtering is periodically updated by the matrices ascertained using the mechanical model.

The deterministic dynamic behavior of the trailing antenna is thus no longer described, as it is in the customary Kalman filtering, by the deterministic term in the Kalman filtering since, in accordance with the invention, the transition matrix, which is ascertained using a mechanical model of the trailing antenna, describes the deterministic dynamic behavior. The time-invariant transition matrix in the customary Kalman filtering is thus repeatedly updated in accordance with the invention.

Based on any selectable mechanical model, any pull point movements and physical characteristics of the trailing antenna are possible, thanks to the invention. In addition, the pull point of the trailing antenna can be assumed at any location, wherein, nonetheless, Kalman filtering can be applied.

In accordance with a preferred embodiment, Kalman-based state vectors are regularly ascertained using the Kalman filtering. Here, the current Kalman-based state vector at one current point in time of the predefined points in time has estimated data of the current locations, orientations and/or shapes of several or all of the segments or the values derived from the values.

Thanks to the Kalman-based state vectors, from which locations, orientations and/or shapes of segments of the trailing antenna can be calculated directly, it is possible to estimate the current shape of the trailing antenna easily.

In accordance with a further preferred embodiment, using the Kalman filtering, a current Kalman-based state vector is determined using a prediction step and a correction step subsequent to the prediction step. Here, in the prediction step, a current uncorrected Kalman-based state vector is initially determined, by multiplying one or more previously determined Kalman-based state vectors by the transition matrix. The current uncorrected Kalman-based state vector is then converted into the correction step in the current Kalman-based state vector.

By multiplying the Kalman-based state vector(s), which were determined prior to the respective current Kalman-based state vector, by the transition matrix, which was determined by means of the mechanical model of the trailing antenna, a result is given for the estimated shape of the trailing antenna in the prediction step, which already takes the deterministic dynamic behavior of the trailing antenna into account and thus offers a basis for an improvement in the correction step.

In accordance with a further preferred embodiment, one or more of the segments each have one or more sensors. The sensors serve to determine the measurement readings for the variables, location, orientation and/or shape of the respective segments and for the readout for the measurement readings determined. The measurement readings of the same measurement variables determined at the current point in time of the defined points in time are depicted in the read-out as a current measurement vector for these measurement variables. In the correction step for the Kalman filtering, the current Kalman-based state vector is then determined by determining the difference between the current measurement vector(s) of one or more measurement variables and the current uncorrected Kalman-based state vector and by weighting by multiplying by a current Kalman matrix. The product is converted into the current Kalman-based state vector by addition with the current uncorrected Kalman-based state vector.

Thanks to the measurement readings of the sensors, which are used in the correction step of the Kalman filtering, a correction can be made to the uncorrected Kalman-based state vector.

In accordance with a further preferred embodiment, the current Kalman matrix is determined using the current covariance matrix of the estimation error of the current uncorrected Kalman-based state vector. Here, the covariance matrix of the estimation error of the current uncorrected Kalman-based state vector is determined using the current transition matrix and the covariance matrix of the estimation error of the previously determined Kalman-based state vector.

By determining the current Kalman matrix with the covariance matrices, a degree of uncertainty in the previously determined Kalman-based state vectors enters the Kalman matrix in order to account for as realistic as possible conditions in the determination of the current Kalman-based state vector.

In accordance with a further preferred embodiment, interferences with the sensors and the error-prone measurement readings caused by this are anticipated. Thus, in addition, a covariance matrix of the error of the measurement readings is determined once at the beginning of the estimation or is regularly redetermined. This covariance matrix is also accounted for in determining the Kalman matrix.

By determining and accounting for the covariance matrix of the error in the sensor measurement readings, a degree of uncertainty for the measurement readings enters the Kalman matrix in order to improve the determination of the current Kalman-based state vector.

In accordance with a further preferred embodiment, the sensor measurement readings are filtered. Thus, the advantage is given that less intensely distributed measurement readings yield less intensely distributed results in the Kalman filtering.

In accordance with a further preferred embodiment, a covariance matrix of an assumed additive process noise is determined once at the beginning of the estimation of the shape or is determined regularly, e.g. at predefined intervals, and is used for the determination of the covariance matrix of the estimation error of the respective uncorrected Kalman-based state vector.

In accordance with a further preferred embodiment, a first Kalman-based state vector for determining subsequent Kalman-based state vectors is determined at the beginning of the estimation of the shape and a first model-based state vector is determined for determining subsequent model-based state vectors based on an assumed shape of the trailing antenna. A shape of the trailing antenna is assumed, in particular, a rectilinear shape, in accordance with the forward movement of the vessel towing the trailing antenna, with which, it is assumed, the actual shape corresponds. This shape is depicted by the first Kalman-based state vector and the first model-based state vector and the further estimation of the shape is based on these first state vectors.

Thanks to the depiction of the assumed shape of the trailing antenna by the first Kalman-based state vector and the first model-based state vector, the estimation of the shape can be initialized.

In accordance with a further preferred embodiment, the mechanical model of the trailing antenna incorporates a mass-spring system. In the mass-spring system, one or more points, e.g. centers of mass or any other points, are defined respectively as a mass for each segment of the trailing antenna. Adjacent masses are regarded as connected together by springs with predefined spring constants, that is, elastically. The estimated time behavior of the mechanical model of the trailing antenna is then determined by the acceleration of the masses, which are created by the elastic forces and by the effects of external forces on the mass-spring system. The effects of external forces are e.g. hydrodynamic forces, due to counter forces caused by displaced fluid, and static buoyancy forces.

Advantageously, any physical characteristics of the trailing antenna can easily be incorporated by a mechanical model of this type.

In accordance with a further preferred embodiment, cyclic values of the model-based state vectors, such as compass readings, which indicate the estimated orientations of the segments, are converted into equivalent linear values prior to integration into the transition matrix. In addition, cyclic readings of the measurement vectors are converted into equivalent linear measurements prior to determining the deviation between the measurement vector and the current uncorrected Kalman-based state vector. The individual values, e.g. in the case of compass readings for the segments included in the state or measurement vectors, can be converted by means of a modified modulo calculation.

Thus, it is possible that, in the case where a value in the state or measurement vector moves beyond its cyclic boundary within a time step, this does not lead to very great remaining differences, e.g. in the transition matrix or in the current Kalman-based state vector. These great remaining differences would lead, in particular, to error-prone Kalman-based state vectors and would distort the estimation of the shape.

In accordance with a further preferred embodiment, the time interval between the predefined points in time is shorter than the time interval between the points in time, in which the location of the pull point is determined. In addition, current locations of the pull point, which are located, in terms of time, between the points in time determined, are then determined by interpolation.

Thus, the advantage arises that the location of the pull point does not have to be determined currently at each point in time of the defined points in time, but that a determination of the location of the pull point is also possible using a lower refresh rate or period.

In accordance with a further preferred embodiment, Kalman-based state vectors are determined using a lower refresh rate than model-based state vectors.

By this means, the calculation effort and hence the electric energy outlay in carrying out the process and operating the device in accordance with the invention can be saved.

In accordance with a further preferred embodiment, the measurement vectors, the model-based state vectors and the Kalman-based state vectors only have discrete values of estimated locations, orientations and/or shapes or discrete values derived from these values. This value discretization of the state and measured variables emerges e.g. due to a spatial discretization of the area to be considered, in which the shape of a trailing antenna is to be estimated. Here, derived values correspond to values which are derived from the actual values of the estimated locations, orientations and/or shapes by mathematical methods such as by multiplication by constants or by modulo calculation.

Further calculation effort and hence electric energy outlay in carrying out the process or and operating the device in accordance with the invention can be saved by discretization of the values since digital processing is possible.

Further embodiments of the invention arise in the subclaims and in the examples of the realization explained in more detail by reference to the drawings. In the drawings:

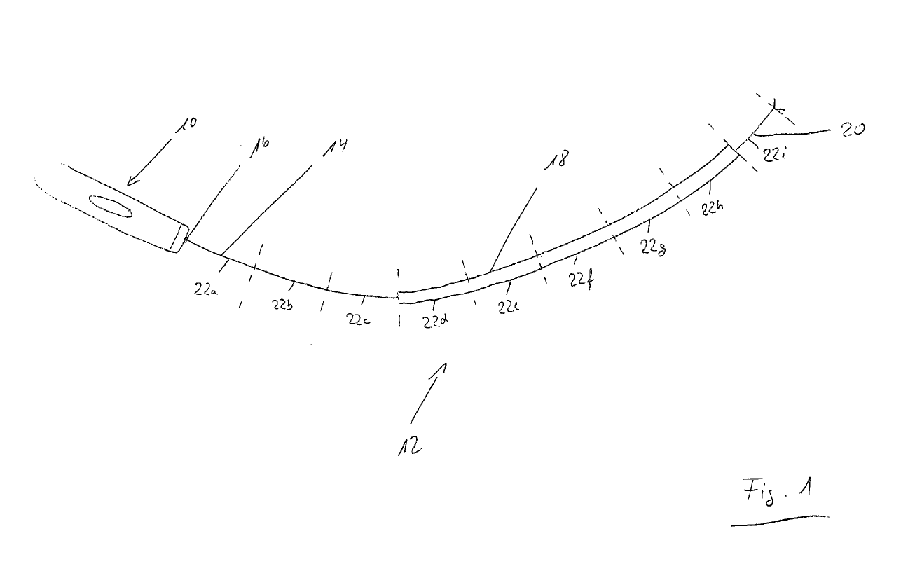

FIG. 1 depicts a plan view of a watercraft with a trailing antenna,

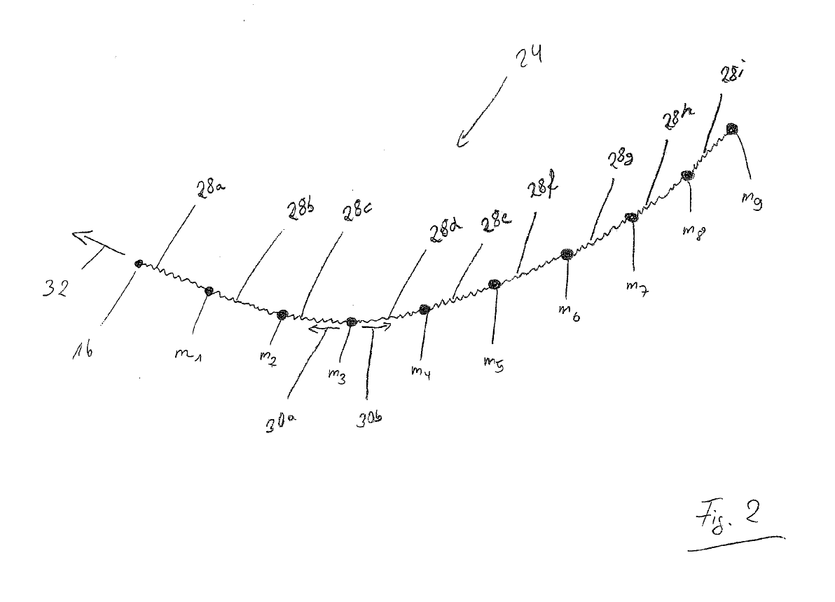

FIG. 2 depicts a mechanical model of the trailing antenna in FIG. 1,

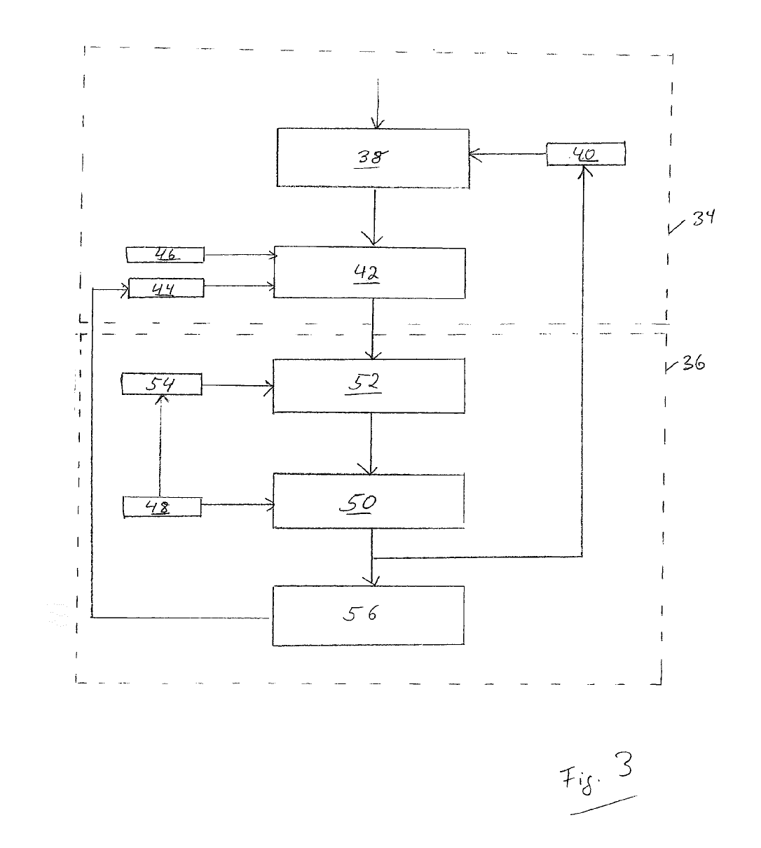

FIG. 3 depicts a Kalman filtering sequence and

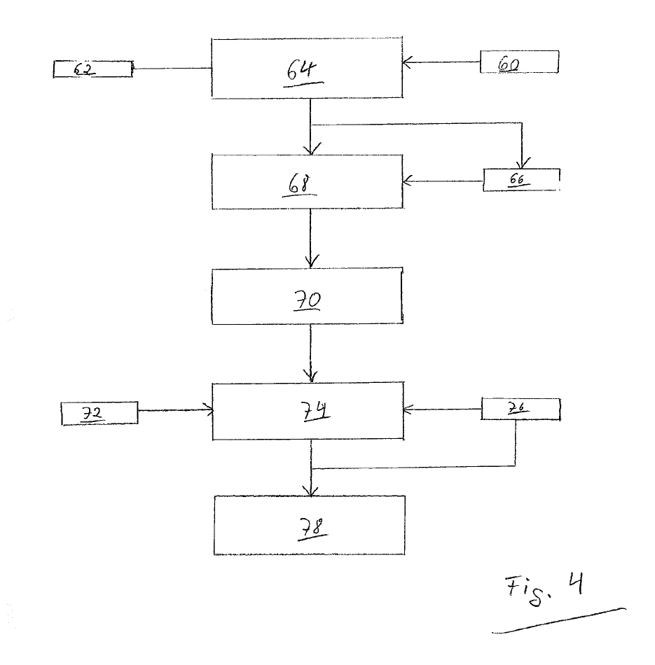

FIG. 4 depicts the sequence of an example of the realization of the method according to the invention.

FIG. 1 depicts the plan view of a watercraft 10 with a trailing antenna 12. The trailing antenna 12 comprises a towing cable 14, which is attached to a point of attachment 16, which is defined as a pull point 16, on the watercraft 10. An acoustic section 18 is connected to the towing cable 14 on the opposite end of the pull point 16. The trailing antenna has an end piece 20 at the end. In addition, an actual trailing antenna can have still further sections, such as vibration dampers, between the towing cable 14 and the acoustic section 18 and between the acoustic section 18 and the end piece 20, which, however, in order to provide a better view, are not depicted. The trailing antenna is now assumed to be divided into segments 22. In FIG. 1, the trailing antenna 12 has been divided into segments 22a to 22i, wherein the trailing antenna 12 can be subdivided to any greater or lesser degree.

FIG. 2 depicts a mechanical model 24 of the trailing antenna 12 in FIG. 1. The mechanical model 24 displays the pull point 16 as well as the masses m₁ to m₉, which are elastically connected by spring elements or springs 28a to 28i. Independently of the segment modeled by the respective mass, the masses m₁ to m₉ are the same or different in size. In addition, the spring constants of the springs 28a to 28i, dependent on the segment modeled by the respective spring, are also the same or different in size. If it is assumed, for example, that, based on its structure, the acoustic section 18 is more elastic along its longitudinal axis than the towing cable 14, alone by this means, different spring constants for the springs emerge, due to which the segments 22 of these two different sections of the trailing antenna 12 must be modeled differently.

In general, in the following, n masses m are assumed, which describe n segments 22. The nth mass mₙ of the nth segment 22 of the mechanical model 24 is then determined, e.g. by using the formula

$${m}_{n} = {ρ}_{n} {l}_{n} π \frac{{d}_{n}^{2}}{4} ,$$

wherein ρₙ is the density of the nth segment 22, lₙ is the length of the nth segment 22 and dₙ is the diameter of the n th segment 22.

If forces acting on the masses mₙ are now assumed and which, taken together, are labeled total force F_{n,ges}, then the acceleration aₙ of the masses mₙ can be determined using the formula

$$\frac{{F}_{n , ges}}{{m}_{n}} = {a}_{n}$$

The total force F_{n,ges} consists of any forces to be taken into consideration in the mechanical model 24, which affect the respective modeled trailing antenna 12. The most important force to be taken into account here is the tractive force 32 of the pull point 16. Other forces are e.g. the weight forces of the segments and the tractive forces 30a, 30b, which affect a segment 22 due to the acceleration of an adjacent segment. The buoyancy of the segments 22 and the counter forces acting on the segments 22 are also incorporated, for example, if these displace water during movement through a body of water.

In addition, the masses m of the mechanical model 24 are initialized at a point in time k₀ by a known location rₙ(k₀) and a known rate vₙ(k₀) of the masses m. Moreover, points in time kᵢ subsequent to the point in time k₀ are also predefined, wherein points in time subsequent in terms of time, have a time interval Δt. Hence, the rate vₙ(kᵢ) of the mess mₙ of the nth segment 22 at the point in time k₁ is then determined by

Vₙ(k₁)=vₙ(k₀)+aₙ(k₀)·Δt

Using the rate determined vₙ(k₁), the rate vₙ(k₂) at the following point in time and, accordingly, the other speeds for further points in time kᵢ can then be determined.

In addition, by reference to the determined rate vₙ(k₁) at the point in time k₁ and the known location r_{n,0}(k₀) at the previous point in time k₀, the location of the mass mₙ of the nth segment 22 in the point in time k₁ is determined by

rₙ(k₁)=rₙ(k₀)+vₙ(k₁)·Δt

Using the determined location rₙ(k₁), the location rₙ(k₂) at the following point in time and, accordingly, the other locations for further points in time kᵢ can be determined. The locations rₙ(k) correspond to e.g. absolute coordinates or vectors for the particular mass mₙ, based on any reference point selected for all masses.

The abovementioned equations describe the updating of the movement state of the mechanical model 24 of the trailing antenna 12 using an explicit integration approach. This is an example of the realization, wherein the determination of the acceleration, velocity and/or positional or locational vectors is not limited to this method. In particular, implicit integration methods can also be used, the update requirements of which are admittedly more costly and less intuitive, but which achieve advantages of speed in their implementation.

Thus, using the mechanical model 24, the location of the masses mₙ and hence of the segments 22 is determined at each point in time kᵢ. The locations of the masses mₙ are then respectively depicted in a model-based state vector x for each point in time kᵢ. The model-based state vector x(k₁) for the points in time kᵢ of the model depicted in FIG. 1 with the masses m₁ to m₉, then, corresponds to

$$x ( {k}_{i} ) = [ \begin{matrix}{r}_{{m}_{1}} ( {k}_{i} ) \\ {r}_{m 2} ( {k}_{i} ) \\ … \\ … \\ {r}_{m 9} ( {k}_{i} )\end{matrix} ]$$

The deviation of a current model-based state vector x(kᵢ), that is, of the state vector x(kᵢ) at the current point in time, from the previous model-based state vector x(kᵢ₋₁), that is, of the previous point in time, is then converted into a current matrix \tilde{F}(kᵢ) of the current point in time kᵢ, so that the formula

x(kᵢ)=\tilde{F}(kᵢ)_{—}x(kᵢ₋₁)

is fulfilled. The current matrix \tilde{F}(kᵢ), that is the matrix \tilde{F}(kᵢ) of the current point in time, can therefore be determined for each point in time kᵢ.

In order to help to explain the invention clearly, FIG. 3 depicts the known sequence of the Kalman filtering for estimating the shape of a trailing antenna 12. The Kalman filtering consists of multiple formulae which are used to integrate the measurements of one or more of the sensors arranged in the segments 22, which are used to determine the measurement readings of the variables, location, orientation and/or shape of the respective segments, in the estimation of the shape. The removal or reduction of interference with the sensors is also made possible by the Kalman filtering.

State vectors \hat{x} for a current point in time kᵢ are estimated for this using Kalman filtering. In order to avoid confusion with the abovementioned model-based state vectors x, the state vectors \hat{x}, which are used in the Kalman filtering, are referred to as Kalman-based state vectors \hat{x} in the present case. The Kalman-based state vectors \hat{x}, however, are comparable to the model-based state vectors x since a Kalman-based state vector \hat{x} at a point in time k, for which the respective Kalman-based state vector \hat{x} has been determined, also describes the estimated shape of the trailing antenna 12.

In the Kalman filtering, a current Kalman-based state vector \hat{x}(kᵢ) of any current point in time kᵢ is determined from a Kalman-based state vector \hat{x}(kᵢ₋₁) of the point in time kᵢ₋₁ previous to the current point in time kᵢ in two steps. The first of these two steps is referred to as the prediction step 34 and the second of these steps is referred to as the correction step 36. These two steps are repeated iteratively.

In the prediction step 34, in accordance with step 38, an uncorrected Kalman-based state vector \hat{x}_{ã}(kᵢ), which is also referred to a priori as a state vector, is initially determined using the Kalman filtering equation of state,

\hat{x}_{ã}(kᵢ)=F(kᵢ)·\hat{X}(kᵢ₋₁)+u(kᵢ)

Here, the current uncorrected Kalman-based state vector \hat{x}_{ã}(kᵢ) is obtained by multiplying the Kalman-based state vector \hat{x}(kᵢ₋₁), which was determined at the point in time previous to the current point in time using a current transition matrix F(kᵢ). The Kalman-based state vector determined at the previous point in time, \hat{x}(kᵢ₋₁), was saved for this determination, in accordance with step 40, in a previous iteration step. The term u(k), which describes the deterministic part of the equation of state of the Kalman filter, is depicted here, wherein this is not further outlined since, in accordance with the invention, this is set to zero later on. Additionally in the Kalman filtering, the covariance matrix of the estimation error of the current uncorrected Kalman-based state vector \hat{x}_{ã}(kᵢ), in accordance with step 42, is determined in the prediction step 34 using

\hat{P}_{ã}(kᵢ)=F(kᵢ)_{—}P(kᵢ₋₁)·F^{T}(kᵢ)+Q

Here, F^{T}(kᵢ) is the transposed current transition matrix F(kᵢ) and \hat{P}(kᵢ₋₁) is the covariance matrix of the estimation error of the Kalman-based state vector \hat{x}(kᵢ₋₁), which was determined at the point in time kᵢ₋₁ prior to the current point in time kᵢ. This covariance matrix \hat{P}(kᵢ₋₁) is respectively determined, as described further below, at the end of the respective correction step 36 for a current Kalman-based state vector \hat{x} for application in the subsequent iteration step and saved (step 44).

In addition, a covariance matrix Q of a process noise is incorporated in order to adjust the previously idealized assumption to the actual conditions by error modeling. This covariance matrix Q was predetermined for a process noise assumed here (step 46).

The sensor data and the sensor data of the segments 22 of the trailing antenna 12 are now considered in the correction step 36. As explained above, one or more of the segments respectively has one or more sensors to determine the measurement readings θ of the variables, location, orientation and/or the shape of the respective segment 22. The measurement readings θ of the same variables are then depicted in a measurement vector z(kᵢ) at the same point in time kᵢ (step 48). For example, it is assumed here that each segment 22 of the trailing antenna 12 has just one sensor. Each sensor takes measurement readings θ, here, by way of example, compass readings θ, that is, the orientation of the respective segment 22 to the earth's magnetic field. If the segments 22 in FIG. 1 are considered and the measurement readings of the segments 22 are indicated by the indices 1 to 9, then a measurement vector z(kᵢ) of a current point in time kᵢ can be represented by

$$z ( {k}_{i} ) = [ \begin{matrix}{ϑ}_{1} ( k ) \\ {ϑ}_{2} ( k ) \\ … \\ … \\ {ϑ}_{9} ( k )\end{matrix} ] .$$

This current measurement vector z(kᵢ) is now used in the correction step 36 to correct the current uncorrected Kalman-based state vector \hat{x}_{ã}(kᵢ). To correct 50 the current uncorrected Kalman-based state vector \hat{x}_{ã}(kᵢ), the difference between the measurement vector z(kᵢ) and the current uncorrected Kalman-based state vector \hat{x}_{ã}(kᵢ) is determined. This difference is weighted by multiplying by a current Kalman matrix \hat{K}(kᵢ). The weighted result is then added to the current uncorrected Kalman-based state vector \hat{x}_{ã}(kᵢ). Thus, the correction is made by

\hat{x}(kᵢ)=\hat{x}_{ã}(kᵢ)+\hat{K}(kᵢ)·(z(kᵢ)−H·\hat{x}_{ã}(kᵢ)),

whereby the current Kalman-based state vector \hat{x}(kᵢ) is obtained. Here, H denotes a matrix designated in the Kalman filtering as an observation matrix or measurement matrix. This measurement matrix H is used to depict the state variables of the Kalman-based state vector \hat{x}(kᵢ) of the variables collected by the sensors. In the abovementioned example, with one sensor for each segment, the measurement matrix H would correspond to the identity matrix.

The current Kalman matrix \hat{K}(kᵢ) used above in the correction step 36 is determined by

\hat{K}(kᵢ)=\hat{P}_{ã}(kᵢ)·H^{T}(H·\hat{P}_{ã}(kᵢ)·H^{T}+R)⁻¹

and is determined prior to determining the current Kalman-based state vector \hat{x}(kᵢ) (step 52). Here, the matrix R corresponds to a covariance matrix, which has been predetermined for assumed measurement errors of the sensors, in accordance with step 54. H^{T} is the transposed measurement matrix H.

After the determination, in accordance with step 50, of the current Kalman-based state vector \hat{x}(kᵢ), the covariance matrix \hat{P}(kᵢ) of the estimation error of this Kalman-based state vector is determined by

\hat{P}(kᵢ)=\hat{P}_{ã}(kᵢ)−\hat{K}(kᵢ)·(H·\hat{P}_{ã}(kᵢ)·H^{T}+R)·\hat{K}^{T}(kᵢ)

56. As already described above, this covariance matrix is saved to determine the following Kalman-based state vector \hat{x}(kᵢ₊₁), which is determined in the next iteration step following the current Kalman-based state vector \hat{x}(kᵢ), in accordance with step 44.

In summary, then, in accordance with the representation in FIG. 3, a current uncorrected Kalman-based state vector \hat{x}_{ã} (kᵢ) is determined in accordance with step 38. In addition, the covariance matrix Q of an assumed process noise is predetermined (in accordance with step 46). Subsequently, the covariance matrix of the estimation error of the current uncorrected Kalman-based state vector \hat{x}_{ã}(kᵢ) is determined, (in accordance with step 42). In addition, the covariance matrix R is predetermined, due to assumed sensor errors (in accordance with step 54) and the Kalman matrix (in accordance with step 52) is determined. The measurements 79 of the sensors are depicted as a measurement vector z(kᵢ) (in accordance with step 48) and the current Kalman-based state vector \hat{x}(kᵢ) is determined using the measurement vector z(kᵢ) and the Kalman matrix \hat{K}(kᵢ) (in accordance with step 50). The current Kalman-based state vector \hat{x}(kᵢ) is then saved (in accordance with step 40) and the covariance matrix \hat{P}(kᵢ) of its estimation error is determined for the following iteration step (in accordance with step 56).

FIG. 4 depicts the sequence of an example of the realization of the method in accordance with the invention. In the method, a mechanical model 24 is initially selected or (in accordance with step 60) determined, which sufficiently accurately depicts the intended trailing antenna 12, the shape of which is to be estimated. A model of this type has been depicted in FIG. 2. The movement of the pull point 16 is then determined (in accordance with step 62) and a current model-based state vector x(kᵢ) of a current point in time kᵢ, as depicted in the description for FIG. 2, is determined using the pull point movement and the mechanical model 24 (step 64). If the current point in time kᵢ is a first point in time k₀ to be considered, then only the current model-based state vector determined x(k₀) is saved (in accordance with step 66) and the technique merges into the next iteration step. If a current point in time kᵢ is assumed, which does not correspond to the point in time k₀, then a current matrix \tilde{F}(kᵢ) is determined using the current model-based state vector x(kᵢ) and a model-based state vector x(kᵢ₋₁) saved beforehand in the previous iteration step or (in accordance with step 68) estimated.

The current matrix \tilde{F}(kᵢ) is then converted into the transition matrix F(kᵢ) (in accordance with step 70). A conversion (in accordance with step 70) is necessary here if the values of the Kalman-based state vectors \hat{x}(kᵢ) and measurement vectors z(kᵢ) for the modeled state vectors x(kᵢ) considered in the following Kalman filtering describe different variables. One example of this would be if, for example, the Kalman-based state vectors \hat{x}(kᵢ) and measurement vectors z(kᵢ) describe the orientations of multiple or all of the segments, while the values of the model-based state vectors x(kᵢ) describe the absolute locations of multiple or all of the segments. In this example, e.g. the shape of the trailing antenna would have to be determined by reference to the known locations of the segments and compass readings arising from these, that is, the orientations of the segments would have to be determined for a shape of this type. Using this, the current matrix \tilde{F}(kᵢ) can then be converted into a current transition matrix F(kᵢ) (in accordance with step 70).

In the next step, sensor measurement readings from the trailing antenna 12, e.g. from depth sensors or compasses, are then incorporated (step 72). A current Kalman-based state vector \hat{x}(kᵢ) is then determined for a current point in time kᵢ using Kalman filtering (in accordance with step 74). For this purpose, the current transition matrix F(kᵢ) of the current measurement vectors z(kᵢ) obtained from the measurement values of the sensors obtained from the mechanical model 24 and a saved Kalman-based state vector \hat{x}(kᵢ₋₁) of the point in time kᵢ₋₁, which was determined prior to the current point in time kᵢ, are used. After determining the current Kalman-based state vector \hat{x}(kᵢ), this is saved for the determination of the following, in terms of time, state vector \hat{x}(kᵢ₊₁) of the following point in time kᵢ₊₁ (in accordance with step 76). The current shape of the trailing antenna 12 is then estimated (in accordance with step 78) from the values of the current Kalman-based state vector \hat{x}(kᵢ), which describe e.g. the current locations, orientations and/or shapes of several or all of the segments 22.

Thus, the shape of a trailing antenna 12 can be estimated using Kalman filtering since the transition matrix F(kᵢ) determined using a mechanical model 24 is repeatedly updated and hence any, even nonhomogeneous, physical characteristics of the segments of the trailing antenna can be considered. In addition, the pull point of the trailing antenna at any location and any movement, in terms of time, of the trailing antenna can be assumed.

All characteristics mentioned in the abovementioned description and in the Claims can be applied, both individually and in any combination with one another. The disclosure of the invention is, therefore, not limited to the combination of characteristics described or claimed. On the contrary, all combinations of characteristics should be viewed as having been disclosed.

1. A method for estimating the shape of an acoustic trailing antenna, wherein the shape is estimated using Kalman filtering, wherein:
the deterministic part (u(kᵢ)) of the equation of state of the Kalman filter is set to zero, consecutive discrete points in time (kᵢ) are predefined and an estimated shape of the trailing antenna is described at each of the predefined points in time (kᵢ), by a model-based state vector (x(kᵢ)),
wherein the model-based state vectors (x(kᵢ)) are determined by the estimated time behavior of a mechanical model of the trailing antenna and by movements of a pull point of the trailing antenna assumed to be known, the deviation of the current model-based state vector (x(kᵢ)) for one or more previous model-based state vectors (x(kᵢ₋₁)) is determined and is considered to be a current matrix (\tilde{F}(kᵢ)) and the current transition matrix (F(kᵢ)) for the Kalman filtering is regularly updated using the matrices determined (\tilde{F}(kᵢ)).

2. The method in accordance with claim 1,
wherein:
the trailing antenna is assumed to be divided into multiple segments and Kalman-based state vectors (\hat{x}(kᵢ)) are regularly updated using Kalman filtering, wherein each Kalman-based state vector (\hat{x}(kᵢ)), each estimated using Kalman filtering, has values describing current locations, orientations and/or shapes of several or all of the segments.

3. The method in accordance with claim 1,
wherein:
in the Kalman filtering, a current Kalman-based state vector (\hat{x}(kᵢ)) is determined using a prediction step and a correction step following the prediction step, wherein a current uncorrected Kalman-based state vector (\hat{x}_{ã}(kᵢ)) is determined in the prediction step by multiplying one or more Kalman-based state vectors determined beforehand (\hat{x}(kᵢ₋₁)) and is converted into the current Kalman-based state vector (\hat{x}(kᵢ)) using the transition matrix (F(kᵢ)) and the current uncorrected Kalman-based state vector (\hat{x}_{ã}(kᵢ)) in the correction step.

4. The method in accordance with claim 3,
wherein:
one or more of the segments each have one or more sensors for the determination of measurement readings (θ) for the variables, location, orientation and/or shape of the respective segments, wherein the measurements (θ) of the same variables at the same point in time (kᵢ) are depicted in a measurement vector (z(kᵢ)), and are determined in the correction step of the current Kalman-based state vector (\hat{x}(kᵢ)) by determining the difference between the measurement vector (z(kᵢ)) and the current uncorrected Kalman-based state vector (\hat{x}_{ã}(kᵢ)), weighted by multiplication by the current Kalman matrix (F(kᵢ)), and the product is converted into the current Kalman-based state vector (\hat{x}(kᵢ)) by addition of the current uncorrected Kalman-based state vector (\hat{x}_{ã}(kᵢ)).

5. The method in accordance with claim 1,
wherein:
the current Kalman matrix (\hat{K}(kᵢ)) is determined using the covariance matrix of the estimation error (\hat{P}_{ã}(kᵢ)) of the current uncorrected Kalman-based state vector (\hat{x}_{ã}(kᵢ)), wherein the covariance matrix (\hat{P}_{ã}(kᵢ)) of the estimation error of the current uncorrected Kalman-based state vector (\hat{x}ₐ(kᵢ)) is determined using the current transition matrix (F(kᵢ)) and the covariance matrix (\hat{P}(kᵢ₋₁)) of the estimation error of the previously determined Kalman-based state vector (\hat{x}(kᵢ₋₁)).

6. The method in accordance with claim 5,
wherein:
interferences with the sensors and the error-prone measurement readings (θ) of the sensors caused by this are assumed, a covariance matrix (R) of these errors of measurement in the measurement readings (θ) of the sensors is determined once at the beginning of the estimation or at predefined intervals and this covariance matrix (R) is used to determine the Kalman matrix (\hat{K}(kᵢ)).

7. The method in accordance with claim 6,
wherein:
the measurements of the sensors are filtered.

8. The method in accordance with claim 5,
wherein:
a covariance matrix (Q) of an assumed additive process noise is determined once at the beginning of the estimation of the shape or at predefined intervals and is used to determine the covariance matrix (\hat{P}_{ã}(kᵢ)) of the estimation error of the respective current uncorrected Kalman-based state vector (\hat{x}_{ã}(kᵢ)).

9. The method in accordance with claim 1,
wherein:
a first Kalman-based state vector (\hat{x}(k₀)) for determining subsequent Kalman-based state vectors ((\hat{x}(kᵢ)) and a first model-based state vector (x(k₀)) for determining subsequent model-based state vectors (x(kᵢ)) by reference to an assumed shape of the trailing antenna (12) are determined at the beginning of the estimation.

10. The method in accordance with claim 1,
wherein:
the mechanical model of the trailing antenna incorporates a mass-spring system, on which one or more points, e.g. centers of mass or any of one or more other points, respectively for each Segment of the trailing antenna are considered as a mass (m) and adjoining masses (m) are considered to be connected to one another by springs and the estimated time behavior of the mechanical model of the trailing antenna is determined by the accelerations of the masses (m), wherein the accelerations are described by the tractive forces of the springs and by external effects of forces on the mass-spring system, in particular, by assumed hydrodynamic forces, assumed counterforces caused by displaced fluid and assumed static buoyancy.

11. The method in accordance with claim 1,
wherein:
cyclic values of the model-based state vectors (x(kᵢ)), such as estimated compass readings of the segments, are converted into equivalent linear values or measurements (θ) prior to determining the current transition matrix (F(kᵢ)) and cyclic measurements (θ) of the measurement vectors (z(kᵢ)) are converted into equivalent linear values or measurements (θ) prior to determining the deviation between the respective measurement vector (z(kᵢ)) and the current uncorrected Kalman-based state vector (\hat{x}_{ã}(kᵢ)).

12. The method in accordance with claim 1,
wherein:
the time interval (Δt) between the defined points in time (kᵢ) is less than the time interval between the points in time, in which the location of the pull point is determined, and current locations of the pull point, which, in terms of time, are between the determined points in time, are determined by interpolation.

13. The method in accordance with claim 1,
wherein:
Kalman-based state vectors ((\hat{x}(kᵢ)) are determined with a lower repetition rate than model-based state vectors (x(kᵢ)).

14. The method in accordance with claim 1,
wherein:
the model-based state vectors (x(kᵢ)) and the Kalman-based state vectors ((\hat{x}(kᵢ))) only exhibit discrete values of estimated locations, orientations and/or shapes or values derived from these values.

15. A device for estimating the shape of an acoustic trailing antenna, wherein the device is designed in such a way as to estimate the shape using a means for Kalman filtering,
wherein:
the device is also designed in such a way as to set the deterministic part (u(kᵢ)) of the equation of state of the Kalman-Filter to zero, to predefine successive discrete points in time (kᵢ) and to describe an estimated shape of the trailing antenna at each of the predefined points in time (kᵢ) by a model-based state vector (x(kᵢ)), wherein the device is designed in such a way as to determine the model-based state vectors (x(kᵢ)) by the estimated time behavior of a mechanical model of the trailing antenna and by the movements of a pull point of the trailing antenna assumed to be known, to determine the deviation of the current model-based state vector (x(kᵢ)) for one or more previous model-based state vectors (x(kᵢ)), to consider each of these deviations to be a current matrix (\tilde{F}(kᵢ)) and to update the current transition matrix (F(kᵢ)) of the Kalman filter regularly using the matrices (\tilde{F}(kᵢ)) determined.
